(19) United States
(12) Patent Application Publication
(10) Pub. No.: US 2021/0088351 A1
(43) Pub. Date: Mar. 25, 2021

(54) METHOD FOR CALCULATING AN AUGMENTED REALITY (AR) DISPLAY FOR DISPLAYING A NAVIGATION ROUTE ON AN AR DISPLAY UNIT, DEVICE FOR CARRYING OUT THE METHOD, TRANSPORTATION VEHICLE AND COMPUTER PROGRAM

(71) Applicant: VOLKSWAGEN AKTIENGESELLSCHAFT, Wolfsburg (DE)

(72) Inventors: Astrid KASSNER, Berlin (DE); Matthias HENNING, Berlin (DE); Norwin SCHMIDT, Westerland (DE)

(73) Assignee: Volkswagen Aktiengesellschaft

(21) Appl. No.: 16/410,817

(22) Filed: May 13, 2019

(30) Foreign Application Priority Data
May 14, 2018 (DE) 10 2018 207 440.2

(51) Int. Cl. G01C 21/36; B60K 35/00

(52) U.S. Cl. CPC G01C 21/365; G01C 21/3632; B60K 35/00; B60K 2370/179; B60K 2370/165; B60K 2370/166; B60K 2370/177; B60K 2370/1529

(57) ABSTRACT

A method for calculating an AR overlay of additional information for a display on an AR display unit. The AR overlay is used for the representation of a navigation route on the AR display unit. The navigation route is specified by a navigation system. The AR overlay is calculated so that a symbol for a target object or a target person is overlaid on the next turn or on the horizon, the symbol being configured so that, besides the information about which target object or which target person is involved, a direction indicator is seen by the driver, in which direction the target object or the target person is to be found.

### PRIORITY CLAIM

This patent application claims priority to German Patent Application No. 10 2018 207 440.2, filed 14 May 2018, the disclosure of which is incorporated herein by reference in its entirety.

### SUMMARY

Illustrative embodiments relate to the technical field of driver information systems, which are also known by the term infotainment system. Such systems are used above all in transportation vehicles. There is, however, also the possibility of using the illustrative embodiments for pedestrians, cyclists, etc. with data glasses. Illustrative embodiments further relate to a correspondingly configured apparatus for carrying out the method, as well as to a transportation vehicle and a computer program.

### BRIEF DESCRIPTION OF THE DRAWINGS

Exemplary embodiments are represented in the drawings and will be explained in more detail below with the aid of the figures.

FIG. 1 shows the principle of the overlaying of information into the field of view of the driver of a transportation vehicle while driving, with the aid of a head-up display;

FIG. 2 shows the typical passenger compartment of a transportation vehicle;

FIG. 3 shows a block diagram of the infotainment system of the transportation vehicle;

FIG. 4 shows a flowchart of a program for calculating the various AR overlays in the course of the disclosed method;

FIG. 5 shows a representation of an AR overlay for the driver on input of a passenger request into a ride-sharing system;

FIG. 6 shows a representation of an AR overlay for the driver after accepting the ride-sharing of the person from whom the ride-sharing request comes;

FIG. 7 shows a representation of an AR overlay for the driver with a navigation representation for the case in which no ride-sharing request has been accepted;

FIG. 8 shows a representation of an AR overlay for the driver with a navigation representation for the case in which a ride-sharing request has been accepted;

FIG. 9 shows a representation of an AR overlay for the driver with a navigation representation for the case in which the ride-sharing person is already in the region of view of the driver;

FIG. 10 shows a representation of an AR overlay for the driver with two navigation representations for the case in which the ride-sharing person has just disappeared from the overlay region of the HUD display unit by closer approach of the transportation vehicle;

FIG. 11 shows a representation of an alternative AR overlay for the driver with a navigation representation for the case in which a ride-sharing request has been accepted; and

FIG. 12 shows a representation of an AR overlay for the driver with a navigation representation for the case in which the driver has input a particular point of his interest.

### DETAILED DESCRIPTION

A future vision in the transportation vehicle industry is to be able to play virtual elements on the windshield of a person's own transportation vehicle, to offer the driver some benefits. So-called “augmented reality” (AR) technology is used. In this case, the real environment is enriched with virtual elements. This has several benefits: looking down on displays other than the windshield is avoided, since much relevant information is imaged on the windshield. The driver thus does not need to take his view off the road. The particular characteristic of AR representations is that accurately positioned localization of the virtual elements in the real environment is possible. The virtual element is also overlaid at the position where the driver is directing his view in the real environment. With these overlays, the real environment can be “superimposed” from the viewpoint of the user and provided with additional information; for example, a navigation path may be overlaid. In this way, less cognitive engagement by the driver is achieved, since no interpretation of an abstract graphic needs to be carried out; rather, intuitive understanding in the sense of normal perception habits may take place.

At present, head-up displays (HUDs) are being used as AR display units in transportation vehicles. These also have the benefit that the image of the HUD appears closer to the real environment. These displays are in fact projection units which project an image onto the windshield. However, depending on the design of the module, from the viewpoint of the driver this image is located from a few meters to 15 meters in front of the transportation vehicle. This has the benefit that the overlaid information is presented in such a way that the driver's eyes are relieved of accommodation activity.

The “image” is in this case formed in the following way: it is less a virtual display than rather a kind of “keyhole” into the virtual world. The virtual environment is theoretically placed over the real world, and contains the virtual objects which assist and inform the driver when driving. The limited display surface of the HUD has the result that an excerpt thereof can be seen. A person thus looks through the display surface of the HUD at the excerpt of the virtual world. Since this virtual environment supplements the real environment, the term “mixed reality” is also used in this context.

At present, work is likewise intensively being carried out into technologies which in the future are intended to allow autonomous driving. A first approach is in this case not to fully relieve the driver of his tasks, but to ensure that the driver can take control of the transportation vehicle at any time. The driver furthermore undertakes monitoring functions. By recent technologies in the field of driver information systems, such as a head-up display, it is possible to inform the driver better about what is happening in the environment of his transportation vehicle.

Because of the current development towards autonomy levels which are higher, but in which many transportation vehicles are controlled by the driver as before, it is to be assumed that corresponding additional information will in the medium-term already be usable for manually driven transportation vehicles and not only in the long-term for highly automated systems. In this context, the solution described in more detail below may be used for both manually controlled and for automatically controlled transportation vehicles.

For the driver/transportation vehicle interaction, the question in this case arises of how this information may be represented in such a way that genuine added value is provided for the human driver and he/she can also rapidly, or intuitively, find the information provided. The following solutions in this field are in this context already known from the prior art.

Most transportation vehicles nowadays have a navigation system to provide target and road guidance for a driver. Furthermore, transportation vehicles having an HUD mounted therein are available on the market, the HUD rejecting design information and to the windshield of a transportation vehicle and allowing the driver to observe the projected information while the driver is looking forwards.

A system and a method for a ride-sharing service are known from US 2016/0364823 A1. A method is disclosed therein, in which a carpooling request is received by a driver. A computer formulates a carpooling proposal, which is directed to the first and second users. A time for a spatially and temporally common carpooling demand is therefore determined.

A method and a system which are configured for obtaining an instruction which instructs a transport vehicle unit to transport a passenger is known from US 2017/0308824 A1. In this case, in one operation the position and the distance of the transport vehicle relative to a meeting point are determined and displayed.

A navigation instrument having a camera is known from WO 2006/132522 A1.

While conventional navigation displays (with the usual LCD displays) generally display schematic representations (for example, an arrow running at a right angle to the right as an indication that it is necessary to turn right at the next opportunity), AR displays offer substantially more effective possibilities. Since the indications can be represented as “part of the environment”, extremely rapid and intuitive interpretations are possible for the user. Nevertheless, the previously known approaches also have various problems, for which no solutions are currently known.

The navigation function inside a transportation vehicle will be assisted more in the future by representations of a head-up display (augmented or with 2D maneuver indications). To assist the user with constant road & route guiding, the system augments a navigation path directly onto the road.

In other situations, however, additional information is also desired. In the scope of future mobility solutions, it is conceivable that the transportation vehicle users will allow other persons to be carried in their transportation vehicle. The mediation of this ride may take place by a request of the passenger to the driver, for example, via a smartphone app. For the driver, the interactions entailed by this (request and agreement of a ride, adaptation of the navigation, pickup of the passenger) should ideally likewise be overlaid as additional information. This should, however, be carried out with as little distraction as possible.

There is therefore a need for further improvements in the route guiding of a transportation vehicle and the feedback to the driver in this regard through the infotainment system.

The disclosed embodiments assist the driver better with route changes, particularly with a view to future mobility solutions.

The disclosed embodiments provide a method for calculating an “augmented reality” overlay for the representation of a navigation route on an AR display unit, an apparatus for carrying out the method, a transportation vehicle, and a computer program. In this case, the overlay serves the purpose of assisting the driver with the longitudinal driving guiding of the transportation vehicle.

The method for calculating an AR overlay for the representation of a navigation route on an AR display unit according to the proposal consists in calculating the AR overlay in such a way that the AR overlay is calculated in such a way that a symbol for a target object or a target person is overlaid on the next turn or on the horizon, the symbol being configured in such a way that, besides the information about which target object or which target person is involved, a direction indicator can be seen by the driver, in which direction the target object or the target person is to be found. The method is particularly beneficial to be used for the new mobility solutions in the manner of a ride-sharing center. The carrying of other persons, especially the pickup and dropping off of the person, is facilitated for the driver. The method may also be used for other everyday circumstances, for example, when the driver is looking for particular facilities, also known as points of interest POI.

At least one beneficial measure of the method is that, when approaching the target object or the target person, the AR overlay for the symbol is calculated in such a way that the symbol is overlaid on the location of the target object or the target person when the target object or the target person is in visual range, the direction indicator being directed on the ground in front of the target object or the target person. The driver thus receives specific assistance. His view is turned directly to the target object or the target person. Prolonged searching for the target person unknown to him or the target object unknown to him is avoided, and the driver is distracted less.

It is furthermore beneficial that, when approaching closer to the target object and the target object or the target person therefore moves out of the overlay region of the AR display unit, the AR overlay for the symbol is calculated in such a way that the symbol is represented at the edge of the overlay region, in such a way that the direction indicator is directed towards the target object or the target person. The driver thus receives further assistance even when the location of the target person or of the target object is reached. The target person can thus be picked up quickly without disrupting the following traffic for a significant length of time. This is beneficial at pickup locations in dense traffic, where there is little opportunity to stop.

The configuration may also be such that the AR overlay, when approaching closer to the target object, for the symbol is calculated in such a way that the symbol appears offset from the edge of the overlay region in the direction of the middle of the road. In this case, the direction indicator indicates where the person is to be found. The information then lies more centrally in the field of view of the driver and indicates that the driver should stop.

It may furthermore be beneficial that the AR overlay for the symbol is calculated in such a way that the symbol is enlarged when the transportation vehicle approaches the target object or the target person. This corresponds to the natural experience that the target object or the target person also becomes larger when approaching.

It is beneficial that the symbol has a speech bubble shape in which an image or a pictogram of the target object or the target person is inserted in the middle of the symbol and the direction indicator is formed at the edge by rotating the speech bubble arrow. This speech bubble shape will be interpreted correctly by most people.

At least one beneficial measure is furthermore that the AR overlay for the representation of the symbol is calculated in such a way that the name or another designation of the target object or the target person is overlaid below the symbol.

It is furthermore beneficial that the AR overlay likewise comprises a specification of distance to the target object or the target person, which is calculated in such a way that the distance specification is overlaid next to the symbol. The driver is thereby informed more accurately.

For an apparatus for carrying out the disclosed method, it is beneficial that the apparatus comprises an AR display unit, a computer unit and a navigation system. A navigation route is calculated by the navigation system, the navigation system being configured in such a way that it periodically recalculates the navigation route to adapt to changing situations, in particular, the traffic conditions. The computer unit carries out the operations for calculating an AR overlay. In this case, the computer unit is configured for the calculation of an AR overlay of the type that a symbol for a target object or a target person is overlaid at the next turn or on the horizon, the symbol being configured in such a way that, besides the information about which target object or which target person is involved, a direction indicator can be seen by the driver, in which direction the target object or the target person is to be found. As explained above in connection with the disclosed method, the solution is of interest for commercial mobility solutions in the manner of a ride-sharing center.

In this case, at least one disclosed embodiment is that the apparatus is equipped with environmental observation methods or mechanisms, with the aid of which recognition of the target person or of the target object is carried out. To this end, one or more cameras may, for example, be fitted to the device. Image recognition methods are used to evaluate the images delivered by the camera. In this case, there are known algorithms with which the image evaluation for the object or the person recognition can be carried out.

The apparatus is configured in such a way that, with the correspondingly programmed computer unit, the calculations of AR overlays which are performed in the corresponding method operations of the disclosed method are carried out.

Moreover, the same benefits as mentioned in the claims with the corresponding method operations apply for the apparatus for carrying out the method with the correspondingly programmed computer unit.

It is beneficial that the display unit of the apparatus is configured as a head-up display. Instead of a head-up display, data glasses which the driver wears, or a monitor on which a camera image, in which the AR overlay is inserted, is displayed, may be used in the apparatus as a display unit.

As mentioned, the disclosure may also be used when the display unit corresponds to data glasses. Then, the disclosed method may even be used for pedestrians, cyclists, motorcyclists, etc.

The apparatus for carrying out the method may be part of a transportation vehicle.

For a computer program which is run in the computer unit of the apparatus to carry out the disclosed method, the corresponding benefit as described for the disclosed method apply. The program may be configured as an app that is loaded into the apparatus by a download from a provider.

The present description illustrates the principles of the disclosure. It is therefore to be understood that persons skilled in the art will be able to conceive of various arrangements which, although not explicitly described here, embody principles of the disclosure and are likewise intended to be protected in their scope.

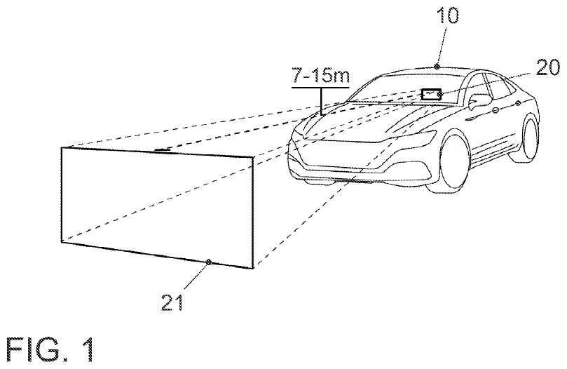

FIG. 1 illustrates the basic functionality of a head-up display. The head-up display 20 is fitted in the transportation vehicle 10 below/behind the instrument cluster in the dashboard region. By projection onto the windshield, additional information is overlaid into the field of view of the driver. The additional information appears in such a way as if it were projected onto a projection surface 21 at a distance of 7-15 m in front of the transportation vehicle 10. Through this projection surface 21, however, the real world remains visible. With the overlaid additional information, so to speak, a virtual environment is generated. The virtual environment is theoretically placed over the real world and contains the virtual objects which assist and inform the driver when driving. However, projection is carried out onto only a part of the windshield, so that the additional information cannot be arranged arbitrarily in the field of view of the driver.

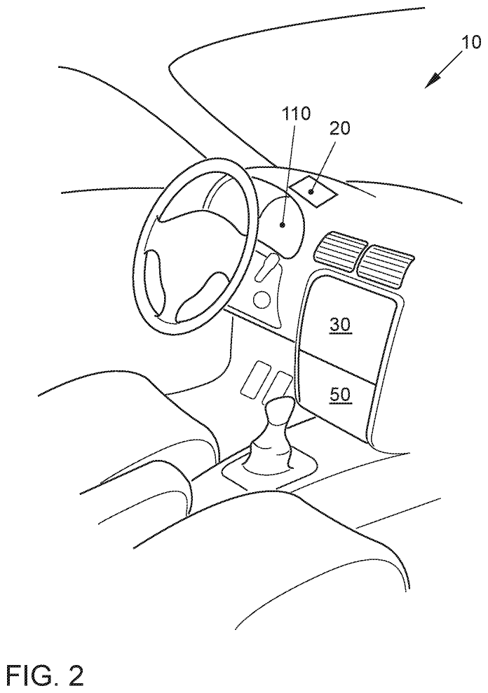

FIG. 2 shows the passenger compartment of the transportation vehicle 10. A transportation vehicle is represented. However, any other desired transportation vehicles could also be envisioned as the transportation vehicle 10. Examples of further transportation vehicles are: coaches, commercial vehicles, in particular, trucks, agricultural machines, construction machines, rail vehicles, etc. Use of the disclosed embodiments would generally be possible for agricultural vehicles, rail vehicles, watercraft and aircraft.

In the passenger compartment, three display units of an infotainment system are highlighted with references. These are the head-up display 20 and a touch-sensitive screen 30, which is fitted in the central console. During driving, the central console is not in the field of view of the driver. For this reason, the additional information is not overlaid on the display unit 30 during driving. Furthermore, the conventional instrument cluster 110 in the dashboard is shown.

The touch-sensitive screen 30 is in this case used, in particular, for operating functions of the transportation vehicle 10. For example, a radio, a navigation system, playback of stored music tracks and/or air-conditioning, other electronic devices or other convenience functions or applications of the transportation vehicle 10 may be controlled thereby. In short, this is often referred to as an “infotainment system”. In transportation vehicles, especially automobiles, an infotainment system refers to the combination of automobile radio, navigation system, hands-free device, driver assistance systems and further functions in a central operator control unit. The term infotainment is a portmanteau word made up of the words information and entertainment. To operate the infotainment system, the touch-sensitive screen 30 (“touchscreen”) is mainly used, this screen 30 being readily visible and operable by a driver of the transportation vehicle 10, but also by a passenger of the transportation vehicle 10. Mechanical operating elements, for example, buttons, control knobs or combinations thereof, for example, rotary push-buttons, may furthermore be arranged in an input unit 50 below the screen 30. Typically, steering-wheel operation of parts of the infotainment system is also possible. This unit is not represented separately, but is regarded as part of the input unit 50.

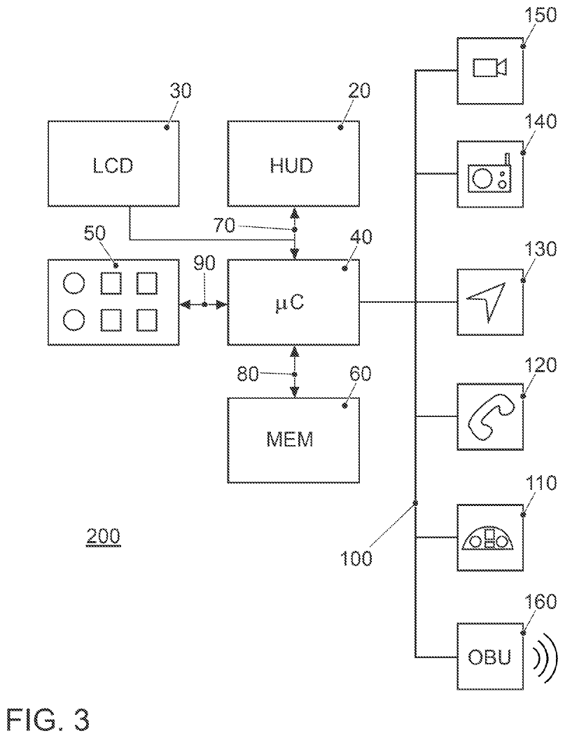

FIG. 3 schematically shows a block diagram of the infotainment system 200 and, by way of example, some subsystems or applications of the infotainment system. The operating apparatus comprises the touch-sensitive display unit 30, a computer device 40, an input unit 50 and a memory 60. The display unit 30 comprises both a display surface for displaying variable graphical information and an operator control surface (touch-sensitive layer) arranged above the display surface for input of commands by a user.

The display unit 30 is connected by a data line 70 to the computer device 40. The data line may be configured according the to the LVDS standard, corresponding to low-voltage differential signaling. Via the data line 70, the display unit 30 receives control data for driving the display surface of the touchscreen 30 from the computer device 40. Via the data line 70, control data of the commands entered are also transmitted from the touchscreen 30 to the computer device 40. Reference number 50 denotes the input unit. Associated with it are the already mentioned operator control elements such as buttons, control knobs, sliders, or rotary push-buttons, with the aid of which the operating person can make entries via the menu guide. Entry is generally understood as meaning selecting a chosen menu option, as well as modifying a parameter, switching a function on and off, etc.

The memory device 60 is connected by a data line 80 to the computer device 40. Stored in the memory 60 is a pictogram list and/or symbol list with the pictograms and/or symbols for the possible overlays of additional information.

The further parts of the infotainment system, camera 150, radio 140, navigation instrument 130, telephone 120 and instrument cluster 110 are connected by the data bus 100 to the apparatus for operating the infotainment system. The high-speed option of the CAN bus according to ISO standard 11898-2 may be envisioned as a data bus 100. As an alternative, the use of a bus system based on ethernet technology, such as BroadR-Reach, could, for example, also be envisioned. Bus systems in which the data transmission takes place via optical waveguides are also usable. The MOST bus (Media Oriented System Transport) or the D2B bus (Domestic Digital Bus) will be mentioned as examples. It will also be mentioned here that the camera 150 may be configured as a conventional video camera. In this case, it takes 25 full images/s, which corresponds to the interlace recording mode of 50 fields/s. As an alternative, a special camera may be used, which takes a plurality of images/s to increase the accuracy of the object recognition in the case of rapidly moving objects. A plurality of cameras may be used for the environmental observation. Besides this, the already mentioned RADAR or LIDAR systems may also be used as a supplement or alternative, to carry out or enhance the environmental observation. For wireless communication inwards and outwards, the transportation vehicle 10 is equipped with a communication module 160. This module is often also referred to as an on-board unit. It may be configured for mobile radio communication, for example, according to the LTE standard, corresponding to Long-Term Evolution. It may likewise be configured for WLAN communication, corresponding to Wireless LAN whether for communication with instruments of the occupants in the transportation vehicle or for vehicle-to-vehicle communication or for vehicle-to-infrastructure communication, etc.

The disclosed method for calculating an AR overlay of additional information for a display on an AR display unit 20 will be explained in detail below with the aid of an exemplary embodiment. In this case, other exemplary embodiments are also discussed.

For the further figures, it is the case that the same reference numbers denote the same fields and symbols as explained in the description of FIGS. 1 to 3.

The procedure of giving a ride to a passenger in a “ride-sharing service” will be explained with the aid of a flowchart and a plurality of depictions of AR overlays, which are overlaid during the procedure.

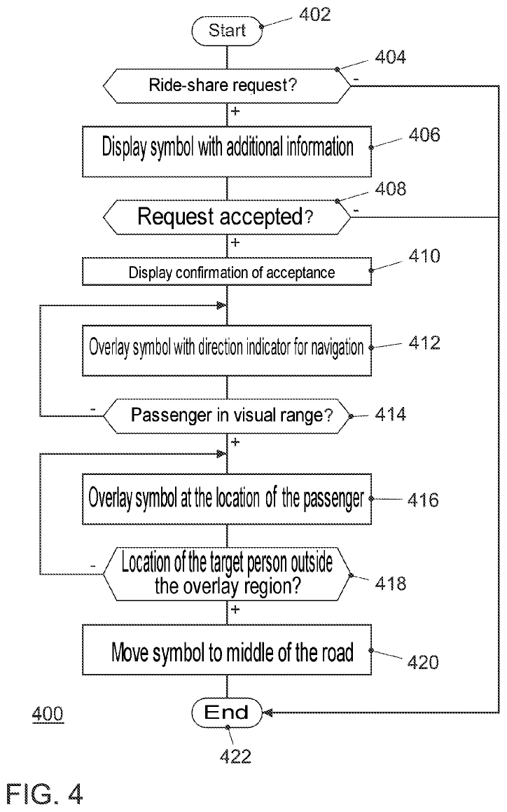

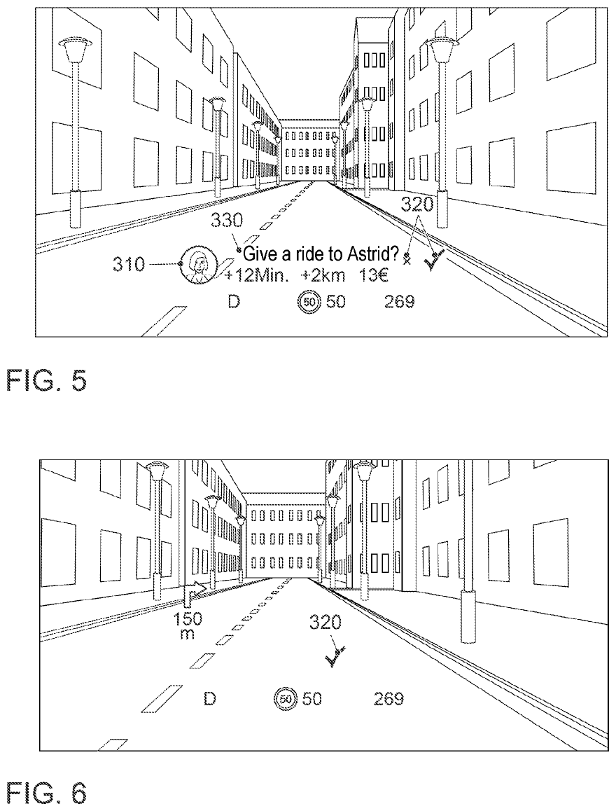

FIG. 4 shows the flowchart of a computer program 400 for calculating AR overlays for the various phases during the initiation of the ride of a passenger and when picking up the passenger. The program 400 is run in the computer unit 40. The program start is denoted by the reference number 402. In the query 104, a check is made as to whether a ride request of a person has arrived. If not, the program ends immediately at operation at 422. If a ride request has arrived, however, in operation at 406 an AR overlay with a symbol 310 and further additional information is calculated and displayed. The display of the AR overlay is shown in FIG. 5. As further additional information, text, such as a question, with the name 330 of the requesting person is overlaid. Further additional information relates to the length of the detour required to pick the person up, the extra time needed for the pickup, and the fare which the person would pay if they were given a lift. Next to this, there are also two response elements 320, which give the driver an operation possibility. By selecting the checkmark and pressing the OK button in the case of steering-wheel operation, the driver can conveniently accept the ride request. By selecting the cross and pressing the OK button in the case of steering-wheel operation, the driver can conveniently decline the ride request. This is typical information which is sent out by such ride-sharing services. Additional information which comes from particular driver assistance systems, such as a road sign detection system, is also overlaid underneath.

In modern transportation vehicles, a multifunction steering wheel MFSW, with which the infotainment system can be operated, is typically installed. The basic operation by the MFSW can be carried out with the following buttons. An operating element is selected with the arrow buttons, and the selected element is confirmed with the OK button (confirm button).

In the further course of the program, a query 408 is carried out. In this, a check is made as to whether the ride request has been accepted. If not, the program is ended in program operation at 422. If the request was accepted, in program operation at 410 the calculation of an AR overlay in which the acceptance of the ride request is confirmed to the driver is performed. An example of this AR overlay is shown in FIG. 6. This is a reduced form in which only the selection checkmark is displayed. In parallel therewith, a recalculation of the driving route is carried out in the navigation system, the pickup location of the passenger is calculated in as an intermediate target.

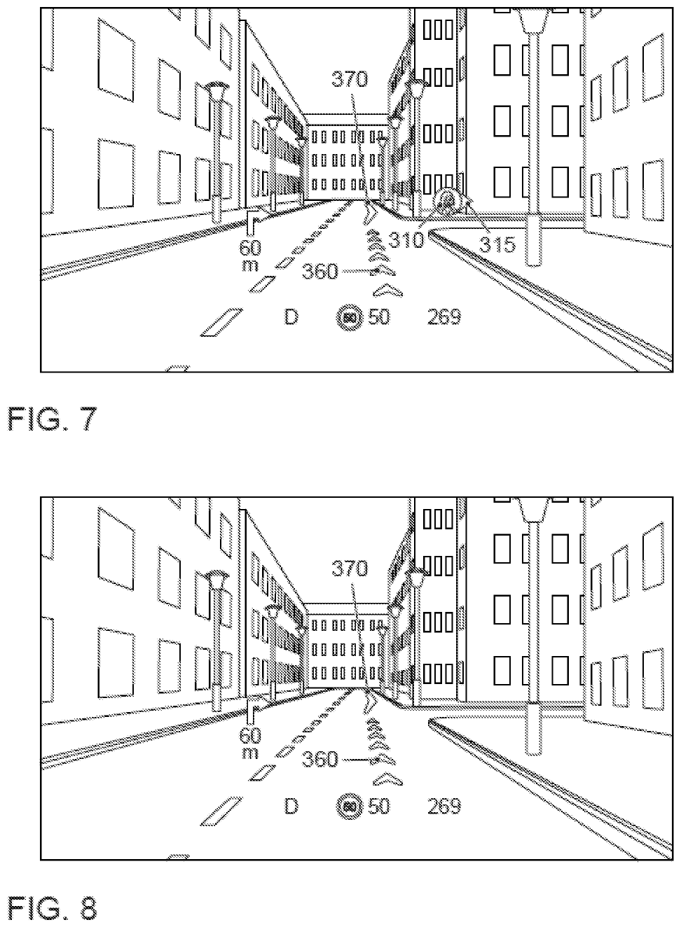

After this, the program changes to calculating AR overlays for the navigation to the pickup location of the passenger. In program operation at 412, an AR overlay is calculated which, in addition to the usual navigation instructions such as navigation path 360 and turning instruction 370, comprises a symbol 310 which has a speech bubble shape and points to the passenger. FIG. 7 shows an example of this overlay. There, the exemplary embodiment is selected in such a way that the speech bubble shape is circular, the area being filled with an image of the passenger. This may be a miniature view of a photograph delivered together with the ride request, which has been forwarded by the system. The AR overlay is calculated with the assistance of the navigation system 130 in such a way that, in the event of an imminent driving maneuver, the speech bubble arrow as a direction indicator 315 is rotated in the direction in which the transportation vehicle 10 must move according to the recalculated navigation path 370.

In comparison therewith, the elements which are represented in the conventional AR overlay during navigation of the transportation vehicle are shown in FIG. 8. The symbol 310 with the direction indicator 315 is accordingly absent in this depiction.

Subsequently, in a query 414, a check is made as to whether the transportation vehicle has already approached the pickup location to such an extent that the passenger is in the region of view. This check may be carried out by on-board method or mechanism. The position of the transportation vehicle 10 is acquired continuously by the navigation system 130. By analyzing the position of the transportation vehicle 10, it is already possible to determine whether the pickup location is in visual range. In addition, the environmental observation method or mechanism, such as the camera 150, may be used to identify the pickup location or the passenger 340. As already mentioned, to this end image evaluation algorithms, for example, a face recognition algorithm, may be used. If the passenger is not in the region of view, the program branches back to operation at 412 and further navigation instructions for the navigation to the pickup location are calculated.

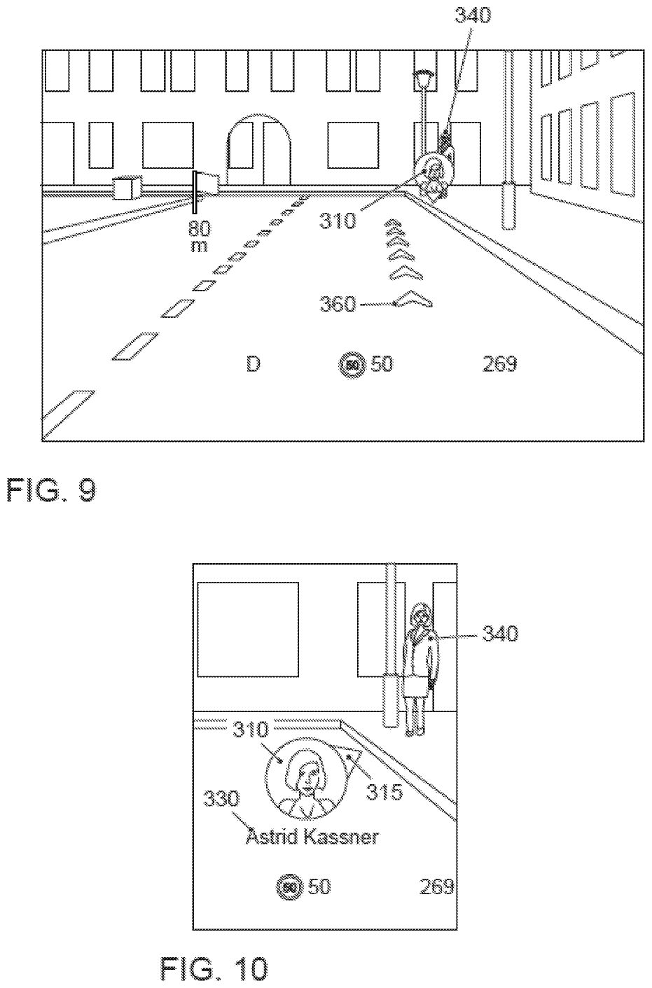

FIG. 9 shows an exemplary AR overlay for the situation in which the passenger is in visual range. The symbol 310 is located directly at the position of the identified person. This also has the purpose of being able to locate the passenger better within a group of persons. The speech bubble arrow points downwards so long as the speech bubble is positioned at the location of the passenger.

In program operation at 418, a check is made as to whether the approach has already progressed to such an extent that the target person moves out of the overlay region 21 of the HUD display unit 20. If not, the program branches back to operation at 416.

If it has, in program operation at 420 the AR overlay is calculated in such a way that, when approaching the pickup location, the speech bubble leaves the position of the passenger and moves in the direction of the middle of the lane, since otherwise it would lie outside the display region. The rotatable direction indicator 315, such as the speech bubble arrow, then no longer points downwards but is rotated in the direction of the passenger. With this overlay, the driver is also indirectly given an indication that he should stop. This corresponds to the conventional procedure when a driver is being instructed by a person who is holding a signaling disk, such as police, firefighters, construction workers, etc. In that case as well, the disk is held in front of the transportation vehicle to the signal to the driver that he should stop. Shortly before the stop, the name 330 of the passenger is overlaid. This procedure is represented in FIG. 10. There, it is represented that the passenger 340 has just disappeared from the overlay region 21, the direction indicator 315 is rotated and the name 330 is overlaid. The program subsequently ends in program operation at 422.

FIG. 11 shows yet another form of the representation of a navigation path 360 with overlay of the symbol 310. In this case, the navigation path is represented as a continuous band and, next to the symbol 310, a distance specification 350 is overlaid to inform the driver of how far it still is to the pickup location.

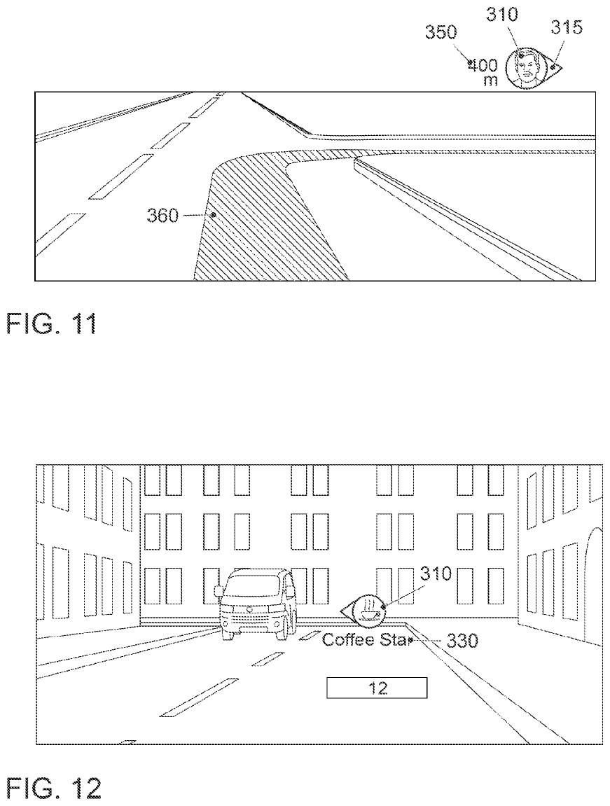

FIG. 12 shows a form of an AR overlay for the case in which a passenger is not intended to be picked up, but instead the driver has input as an intermediate target a point of his interest, corresponding to a point of interest POI. For the case as well, the symbol 310 is configured as a speech bubble. Underneath, a designation 330 of the POI is also overlaid in text form. The use of the speech bubble as a symbol may therefore also be applied to static objects. In this case as well, the speech bubble would be located directly over the POI as long as it is within the display region of the head-up display 20. When approaching closer, the described repositioning in the direction of the middle of the lane would again be carried out.

All examples mentioned herein, as well as related wordings, are to be interpreted without restriction to such mentioned examples. For example, it will be realized by persons skilled in the art that the block diagram represented here represents a conceptual view of an exemplary circuit arrangement. Similarly, it is to be understood that a represented flowchart, state transition diagram, pseudocode and the like represent different options of the representation of processes, which can be stored essentially in computer-readable media and can therefore be carried out by a computer or processor. The object mentioned in the patent claims may expressly also be a person.

It should be understood that the proposed method and the associated apparatuses may be implemented in various forms of hardware, software, firmware, special processors or a combination thereof. Special processors may comprise application-specific integrated circuits (ASICs), a reduced instruction set computer (RISC) and/or field-programmable gate arrays (FPGAs). Optionally, the proposed method and the apparatus are implemented as a combination of hardware and software. The software may be installed as an application program on a program memory apparatus. Typically, it is a machine based on a computer platform which comprises hardware, for example, one or more central processing units (CPU), a random-access memory (RAM) and one or more input/output (I/O) interface(s). An operating system is typically furthermore installed on the computer platform. The various processes and functions which have been described here may be part of the application program or a part which is carried out by the operating system.

The disclosure is not restricted to the exemplary embodiments described here. There is latitude for various adaptations and modifications which the person skilled in the art would take into consideration as also belonging to the disclosure on the basis of his technical knowledge.

The disclosed embodiments may be used whenever the field of view of a driver, an operating person or simply only a person with data glasses, may be enhanced with AR overlays.

### LIST OF REFERENCES

10 transportation vehicle
20 head-up display HUD
21 virtual projection surface
30 touch-sensitive display unit
40 computer unit
50 input unit
60 memory unit
70 data line to the display unit
80 data line to the memory unit
90 data line to the input unit
100 data bus
110 instrument cluster
120 telephone
130 navigation instrument
140 radio
150 camera
160 communication module
200 infotainment system
310 symbol
315 direction indicator
320 response option
330 designation
340 target person
350 distance specification
360 navigation path
370 turning instruction
400 computer program
402 various
422 program operations

1. An apparatus for carrying out a method for calculating an AR overlay (augmented reality overlay) for the representation of a navigation route on an AR display unit, wherein the navigation route is calculated by a navigation system, wherein the AR overlay is calculated so a symbol for a target object or a target person is overlaid on the next turn or on the horizon, the symbol is configured so that, besides the information about which target object or which target person is involved, a direction indicator is seen by the driver, in which direction the target object or the target person is to be found,
wherein the apparatus comprises:
an AR display unit corresponding to augmented reality overlay;
a navigation system by which a navigation route is calculated; and
a computer unit for calculating an AR overlay,
wherein the computer unit is configured for the calculation of an AR overlay where a symbol for a target object or a target person is overlaid at the next turn or on the horizon, the symbol being configured so that a direction indicator is seen by the driver in which direction the target object or the target person is to be found.

2. The apparatus of claim 1, further comprising environmental observation means for aiding in recognizing the target person or the target object.

3. The apparatus of claim 1, wherein the computer unit is configured to carry out the calculations of AR overlays for aiding in recognizing the target person or the target object.

4. The apparatus of claim 1, wherein the display unit is a head-up display (HUD) or data glasses.

5. A transportation vehicle, comprising an apparatus for carrying out a method for calculating an AR overlay (augmented reality overlay) for the representation of a navigation route on an AR display unit, wherein the navigation route is calculated by a navigation system, wherein the AR overlay is calculated so a symbol for a target object or a target person is overlaid on the next turn or on the horizon, the symbol is configured so that, besides the information about which target object or which target person is involved, a direction indicator is seen by the driver, in which direction the target object or the target person is to be found,
wherein the apparatus comprises:
an AR display unit corresponding to augmented reality overlay;
a navigation system by which a navigation route is calculated; and
a computer unit for calculating an AR overlay,
wherein the computer unit is configured for the calculation of an AR overlay where a symbol for a target object or a target person is overlaid at the next turn or on the horizon, the symbol being configured so that a direction indicator is seen by the driver in which direction the target object or the target person is to be found.

6. A computer program run on a computer unit, wherein the computer program is configured to carry out a method for calculating an AR overlay (augmented reality overlay) for the representation of a navigation route on an AR display unit, wherein the navigation route is calculated by a navigation system, wherein the AR overlay is calculated so a symbol for a target object or a target person is overlaid on the next turn or on the horizon, the symbol is configured so that, besides the information about which target object or which target person is involved, a direction indicator is seen by the driver, in which direction the target object or the target person is to be found.

7. A method for calculating an AR overlay (augmented reality overlay) for the representation of a navigation route on an AR display unit, wherein the navigation route is calculated by a navigation system, wherein the AR overlay is calculated so a symbol for a target object or a target person is overlaid on the next turn or on the horizon, the symbol is configured so that, besides the information about which target object or which target person is involved, a direction indicator is seen by the driver, in which direction the target object or the target person is to be found.

8. The method of claim 7, wherein the AR overlay for the symbol is calculated so that the symbol is overlaid on the location of the target object or the target person when the target object or the target person is in visual range when approaching the target object or the target person, the direction indicator is directed on the ground in front of the target object or the target person.

9. The method of claim 7, wherein the AR overlay for the symbol is calculated so that the symbol is represented at the edge of the overlay region when approaching closer to the target object and the target object or the target person moved out of the overlay region so that the direction indicator is directed towards the target object or the target person.

10. The method of claim 9, wherein the AR overlay for the symbol is calculated so that the symbol appears offset from the edge of the overlay region in the direction of the middle of the road when approaching closer to the target object.

11. The method of claim 9, wherein the AR overlay for the symbol is calculated so that the symbol is enlarged when the transportation vehicle approaches the target object or the target person.

12. The method of claim 7, wherein the symbol has a speech bubble shape in which an image or a pictogram of the target object or the target person is inserted in the middle of the symbol and the direction indicator is formed as a direction arrow at the edge.

13. The method of claim 12, wherein the direction arrow is integrated as a speech bubble arrow into the edge of the symbol.

14. The method of claim 7, wherein the AR overlay for the representation of the symbol is calculated so that the name or another designation of the target object or the target person is overlaid below the symbol.

15. The method of claim 12, wherein the AR overlay further comprises a specification of distance to the target object or the target person which is calculated so that the distance specification is overlaid next to the symbol.
